(19) United States
(12) Patent Application Publication
(10) Pub. No.: US 2013/0027548 A1
(43) Pub. Date: Jan. 31, 2013

(54) DEPTH PERCEPTION DEVICE AND SYSTEM

(71) Applicant: David S. Gere, Palo Alto, CA (US)

(72) Inventor: David S. Gere, Palo Alto, CA (US)

(73) Assignee: Apple Inc., Cupertino, CA (US)

(21) Appl. No.: 13/193,561

(22) Filed: Jul. 28, 2011

(51) Int. Cl. H04N 7/18; G01C 3/08

(52) U.S. Cl. 348/140; 356/4.01; 348/E07.085

(57) ABSTRACT

A system for determining a distance to a object or a depth of the object. The system includes a first image capturing device, which may include a lens and an image sensor. The system also includes a first laser source. The first laser source is configured to emit a fan shaped laser beam to intersect at least a portion of a field of view of the image capturing device.

### FIELD

The present invention relates generally to electronic devices, and more specifically, to electronic devices for determining depth or distance to an object.

### BACKGROUND

Depth sensing is an estimate or determination of the depth of an object as viewed from another object or a person. Most current devices that include a depth sensing function may require complicated and expensive sensors, which may in turn require complicated algorithms in order to process data collected by the sensors. However, depth or distance determination may be useful for many devices. For example, cameras may produce better images based on depth data of an object, as a lens of the camera may better focus on an object when the object's depth is known.

Some cameras may include an auto focusing feature. The auto focus feature may be able to determine by approximation or iteration the approximate distance of an object in order to focus a lens on an object. For example, the auto focus may sample different images or sensor readings and with each sample, the auto focus may adjust accordingly until the proper focus is achieved. Other auto focus techniques may include transmitting a sound wave or an infrared signal. For either of these wave methods, the camera transmits a wave and then captures or monitors the wave. The camera may then determine the values of the reflected wavelength and determine the distance the object is from the camera. For example, the time difference between the time that an infrared light wave pulse is produced and when it is received back after reflection allows the camera to estimate the distance to the object.

### SUMMARY

Examples of the disclosure may include a system for determining a distance to a object. The system includes a first image capturing device, which may include a lens and an image sensor. The system also includes a first laser source. The first laser source is configured to emit a fan shaped laser beam to intersect at least a portion of a field of view of the image capturing device.

Other examples of the disclosure may include an electronic device. The electronic device (such as a computer or smart phone) may include a processor and a camera, the camera may be in communication with the processor. Additionally, the electronic device includes a first laser source configured to emit a first fan shaped laser beam to intersect at least a portion of a field of view of the camera.

Yet other examples of the disclosure may include a depth detection device. The device may include a lens and an image sensor configured to capture an image of light transmitted through the lens. The device may also include a laser source configured to emit a laser beam trackable by the lens and having a width that increases in dimensions away from the laser source.

### BRIEF DESCRIPTION OF THE DRAWINGS

FIG. 1A is a side elevation view of a system for determining a depth of an object.

FIG. 1B is a top plan view of the system of FIG. 1A.

FIG. 2 is a block diagram of the system of FIG. 1A.

FIG. 3A is a front elevation view of a camera including the system of FIG. 1A.

FIG. 3B is an isometric view of a computer including the system of FIG. 1A.

FIG. 3C is a front elevation view of a mobile electronic device including system of FIG. 1A.

FIG. 4 is a side elevation view of the system of FIG. 1A illustrating three objects within a field of view of the image capture device intersecting a laser beam.

FIG. 5A is an exemplary image of a position of a point of a reflection of the laser beam off of a first object of FIG. 4.

FIG. 5B is an exemplary image of a position of a point of a reflection of the laser beam off of a second object of FIG. 4.

FIG. 5C is an exemplary image of a position of a point of a reflection of the laser beam off of a third object of FIG. 4.

FIG. 5D is an exemplary chart illustrating an exemplary relationship between a height of an object in an image of a beam reflection and the depth or distance of an object from an image capture device.

FIG. 6A is a top plan view of the system of FIG. 1A with three objects of varying depths positioned within a field of view of the image capture device.

FIG. 6B is an exemplary image of the beam reflection off the objects within the field of view as captured by the image capture device of FIG. 6A

FIG. 7 is a top plan view of a second example of the system of FIG. 1A including multiple image capturing devices.

FIG. 8 is a side elevation view of a third example of the system of FIG. 1A including multiple laser sources.

FIG. 9 is a side elevation view of a fourth example of the system of FIG. 1A including a second image capturing device and a second laser source angled different than the image capturing device and the laser beam source.

FIG. 10 is a fifth example of the system of FIG. 1A including two additional laser sources and additional lenses on the image capturing device.

FIG. 11A is a perspective view of the electronic device of FIG. 3C illustrating a first application of the system of FIG. 1A.

FIG. 11B is a side elevation view of the electronic device of FIG. 11A.

FIG. 12 illustrates the computer of FIG. 3B incorporating the system of FIG. 1A to detect a user.

### SPECIFICATION

### Overview

The disclosure may take the form of a depth perception or depth determination device and system. The system may include an image capturing device (e.g., lens and image sensor) and a laser source for emitting a laser beam that at least partially overlaps the field of view (FOV) of the image capturing device. The laser beam is a fan-shaped or other shaped beam having a length and a width that vary based on a distance to an object. In one example, the laser beam fans outwards across at least a portion of the FOV of the camera. As the laser beam encounters an object, some of the light from the beam is reflected back towards the image capturing device. This light reflection allows for an intersection point between the beam and the object to be determined. The image capturing device then may capture an image of the laser beam as projected into the FOV. The captured image may then be analyzed to determine the depth of an object within the FOV.

In one example, an image of the laser beam may be isolated and then analyzed in order to determine an object's depth or distance from the image capturing device. The image capturing device may capture a first image before the laser beam is emitted, capture a second image as the laser beam is emitted, and then isolate the laser beam image from the other objects captured with each image. If the laser beam contacts an object, the reflected image or appearance of the laser will be modified, as the beam will generally trace along the surface of the object. By analyzing the image of the laser beam (as the distance to the laser source and original dimensions of the beam are known) depth information for objects within a “slice” of the beam may be determined. Furthermore, by collecting a first set for data for a particular beam location and then moving the beam to a second location a two-dimensional depth map of the scene may be created to highlight the depth of different objects in the camera FOV.

The laser beam may include light in the visible or non-visible spectrum. In some instances, the laser beam may be within the non-visible spectrum so that a user may not be able to see the laser beam as it fans across the FOV of the image capturing device. In this manner, the system may be able to detect a user or object without projecting a visible light or indicator.

The system may be incorporated into a variety of devices, such as computers, mobile electronic devices, digital cameras, security systems, automobiles, and so on. Substantially any device or system that may require or utilize depth knowledge may incorporate the system. Additionally, because the system may not require expensive sensors or iterative data estimate, depth sensing functions may be able to be included in more devices. For example, many cameras with an auto focus may be expensive due to the advanced sensors and processing techniques. On the contrary, this system may require a relatively inexpensive sensor (a laser beam and image capturing device). Additionally, the depth determination of an object may be directly related to the laser beam reflection. Therefore, the data processing may not require complicated algorithms to operate.

### DETAILED DESCRIPTION

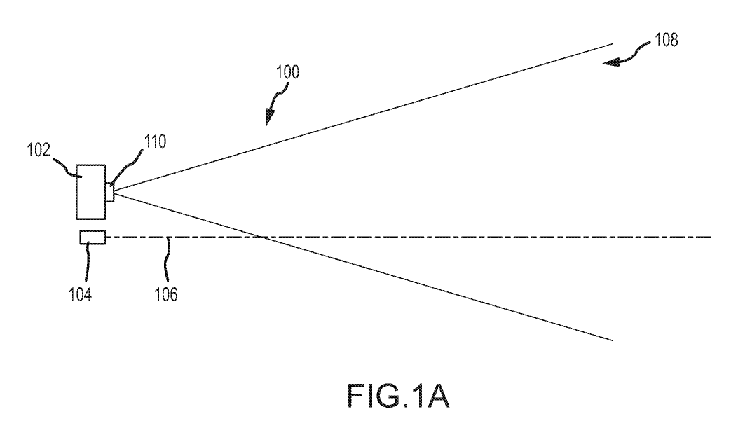

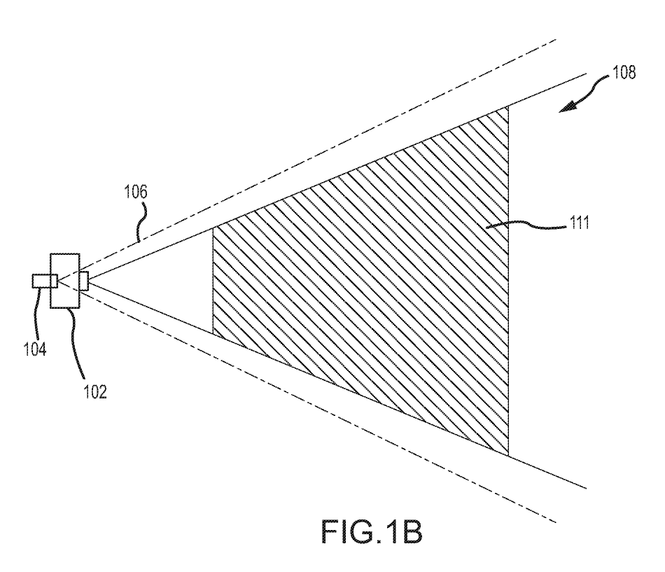

The system for determining the depth or distance of an object from a device may include an image capturing device and a laser source. FIG. 1A is a side view of a system 100 for determining depth including an image capturing device 102 and a laser source 104. The image capturing device 102 may include a lens 110 with a FOV 108. The lens 110 FOV 108 may be a generally conical shape (however, other shapes are possible), and may be configured to have substantially any degree of view. The laser source 104 is positioned to emit a beam 106 that at least partially intersects the FOV 108 at intersection 111.

It should be noted that the FOV 108 is a region in space that may define a volume, and the image capture device 102 may “see” an object as defined by a direction of the object relative to the line of sight of the lens 110. On the other hand, the beam 106 may be two-dimensions, as it may include a length and width. Therefore, as shown in FIG. 1A, the beam 106 appears as a line, but as viewed in FIG. 1B, fan shape of the beam 106 is apparent and the width increases as the beam 106 is farther from the laser source 104.

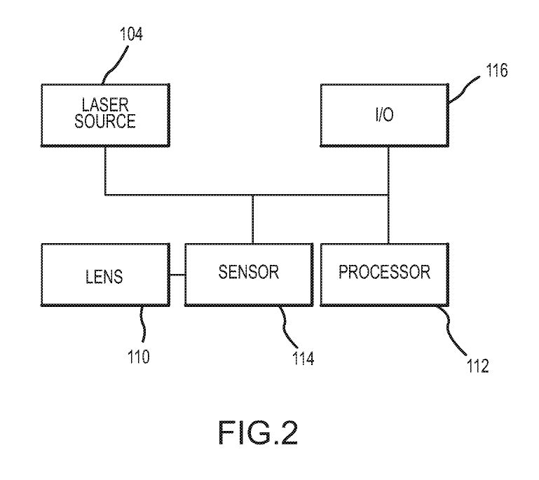

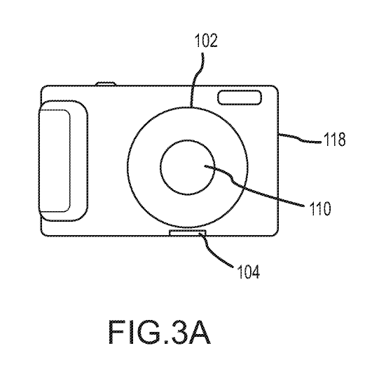

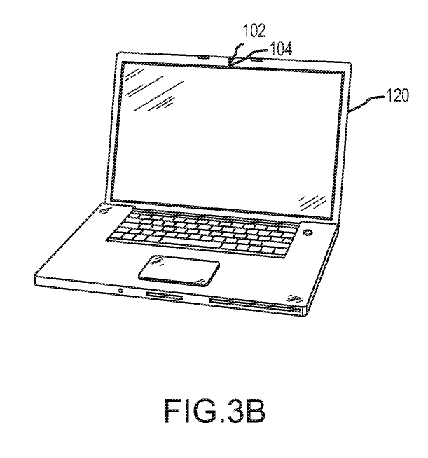

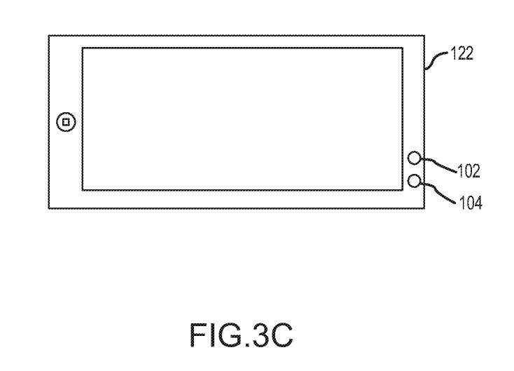

FIG. 2 is a block diagram of the system 100 which may be incorporated into a single device, e.g., an exemplary device as shown in FIGS. 3A-3C. For example, the system 100 may include the lens 110, the laser source 104, a processor 112, a sensor 114, and/or an input/output interface 116. Each element may be in communication (either optically or electronically) with one another For example, the lens 110 may transmit light optically to the sensor 114, which may then communicate electronically via a system bus, communication cables, wireless (such as, Internet, Ethernet, Bluetooth), or other communication mechanism to the other elements.

The lens 110 may be substantially any type of optical device that may transmit and/or refract light. In one example, the lens 110 is in optical communication with the sensor 114, such the lens 110 may passively transmit light from the FOV 108 to the sensor 114. The lens 110 may include a single optical element or may be a compound lens and include an array of multiple optical elements. In some examples, the lens 110 may be glass or transparent plastic; however, other materials are also possible. The lens 110 may additionally include a curved surface, and may be a convex, bio-convex, plano-convex, concave, bio-concave, and the like. The type of material of the lens as well as the curvature of the lens 110 may be dependent on the desired applications of the system 110.

The laser source 104 may be substantially any type of device configured to produce a light amplification by stimulated emission of radiation (laser) beam or other coherent directional beam of light. The laser source 104 may include an active laser material (e.g., ruby, helium-neon, argon, semiconductor), a source of excitation energy (e.g. electricity, optical energy), and a resonator or feedback mechanism (e.g., a mirror). For example, the laser source 104 may be a gas laser that may discharge gas to amply light coherently, a solid-state laser, a semiconductor or diode laser, a photonic crystal laser, and so on. Furthermore, the laser source 104 may be configured to emit light having substantially any range of wavelengths. For example, the beam 106 may be visible, infrared, near infrared, medium wavelength infrared, long wavelength infrared, or far infrared. The beam 106 may be able to be captured or otherwise determined by the sensor 114. The laser source 104 may be configured to emit the beam 106 as a particular shape (e.g., fan-shaped) or may include a filter or cap including an aperture in order to direct the beam 106 into the desired shape.

Although in various embodiments described herein the beam 106 may be described as being laser, it should be noted that other directional light beams may also be used. For example, in some embodiments, a light source producing an incoherent directional beam may be used.

In one example, the laser source 104 may emit the beam 106 in a fan shaped pattern. In the fan pattern, the beam 106 may originate from approximately a single point and fan or spread outwards along its width to form a sector or triangular shape. For example, as the beam 106 reflects off a planar object, the beam 106 may have a curved terminal end to form a sector (a rounded portion of a circle connected by two radial lines) or may have a straight terminal end to form a sector or a triangular shape. Along its length the beam 106 may be substantially horizontal. Therefore, as viewed from a side elevation the beam 106 may appear as a horizontally extending line (see FIG. 1A) and then as viewed from a top or bottom plan view, the beam 106 may appear as having a triangular shape (see FIG. 1B). Additionally, when the beam 106 encounters and reflects off of a planar surface, the beam may appear as a substantially horizontal line. Without encountering an object the beam 106 may propagate infinitely. It should be noted that other shapes for the beam 106 are envisioned. Further, the width of the beam 106 may be customized or varied depending in the desired FOV or the angle of depth sensing desired. For larger FOVs a wider beam may be used so that more objects within the FOV may contact the beam 106.

The sensor 114 may be substantially any type of sensor that may capture an image or sense a light pattern. The sensor 114 may be able to capture visible, non-visible, infrared and other wavelengths of light. Additionally, the sensor 114 may be incorporated into the image capturing device 102, or another device in optical communication with the lens 110. The sensor 114 may be an image sensor that converts an optical image into an electronic signal. For example, the sensor 114 may be a charged coupled device, complementary metal-oxide-semiconductor (CMOS) sensor, or photographic film. The sensor 114 may also include a filter that may itself filter different wavelengths.

The processor 112 may be substantially any type of computational device, such as a microprocessor, microcomputer, and the like. The processor 112 may control aspects of the sensor 114, laser source 104, and/or image capturing device 102. For example, in some embodiments, the system 100 may be implemented within a mobile computing device and the processor 112 may control each of the elements of the system 100. Additionally, the processor 112 may perform computations for analyzing images captured by the image capturing device 102 to determine the depth of objects within the FOV 108 of the lens 110.

The input/output interface 116 may communicate from and between different input sources and/or devices. In some instances, the system 100 may be implemented within a computer, camera, or mobile electronic device and the input output interface 116 may include, but not limited to, a mouse, keyboard, capacitive touch screen, or universal serial bus.

FIG. 3A illustrates a camera 118 including the lens 110 and the laser source 104. FIG. 3B illustrates a computer 120 including the lens 110 and the laser source 104. FIG. 3C illustrates a mobile electronic device 122 including the lens 110 and the laser source 104. Referring to FIGS. 2-3C, the system 100 may be integrated into a single device, e.g., camera 118, computer 120, or mobile device 122. Or, in other embodiments, the system 100 may be included as separate devices. For example, the computer 120 may be in communication with the camera 118 and portions of the system 100 may be included in each device, e.g., the lens 110 may be included with the camera 118 and the processor 112 may be included in the computer 120.

The camera 118 may be substantially any type of image capture device. For example, a film camera or a digital camera. The camera 118 may be incorporated into another device, such as the computer 120 or the mobile device 122.

The computer 120 may be substantially any type of computing device such as a laptop computer, tablet computer, desktop computer, or server. The computer 120 may include network communications, a display screen, a processor, and/or input/output interfaces. Similarly, the mobile electronic device 122 may be substantially any type of electronic device such as a mobile phone, smart phone (e.g., iPHONE by Apple, Inc.), or a digital music player.

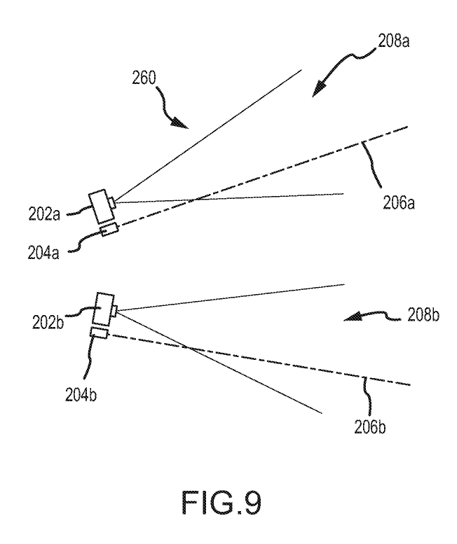

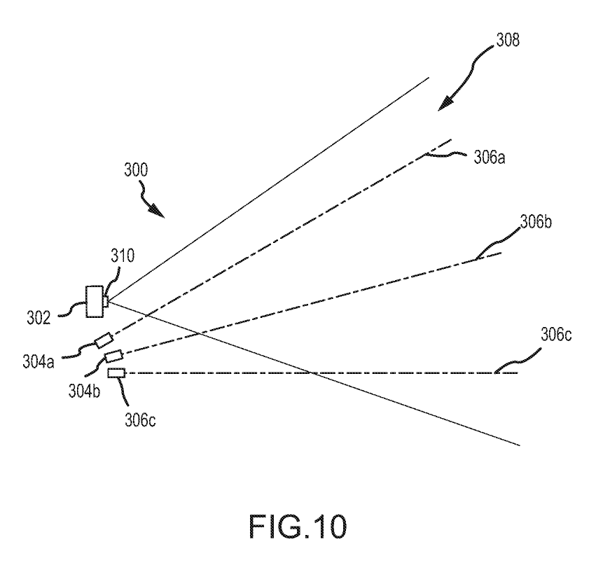

Referring back to FIGS. 1A and 1B, the image capturing device 102 through the lens 110 may include a FOV 108 that may expand in a general cone, frustum, or triangular shape from the lens 110 outwards away from the image capturing device 102. The beam 106 may be projected (as best seen in FIG. 1B) in a sector, fan, triangular or frustum shape so as to partially overlap at an intersection 111 at least a portion of the FOV 108. The beam 106 may include a two-dimensional beam that may project outwards from the laser source 104. In one embodiment, the beam 106 may slice a horizontal plane that may be substantially parallel with the image capturing device 102. However, in other embodiments, (see, e.g., FIGS. 9 and 10), the beam 106 may be projected at various angles with respect to the image capturing device 102 and/or the FOV 108.

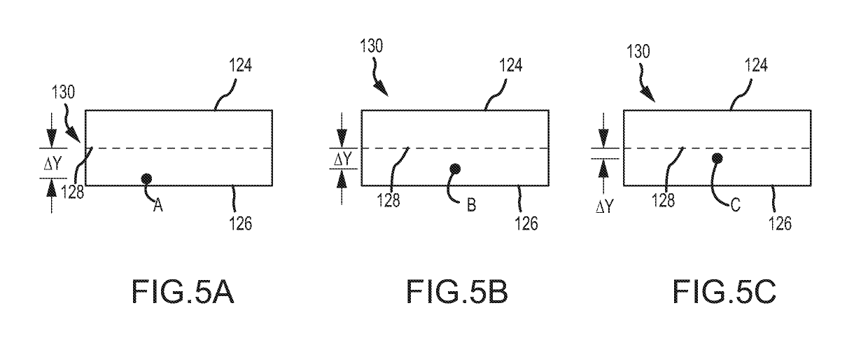

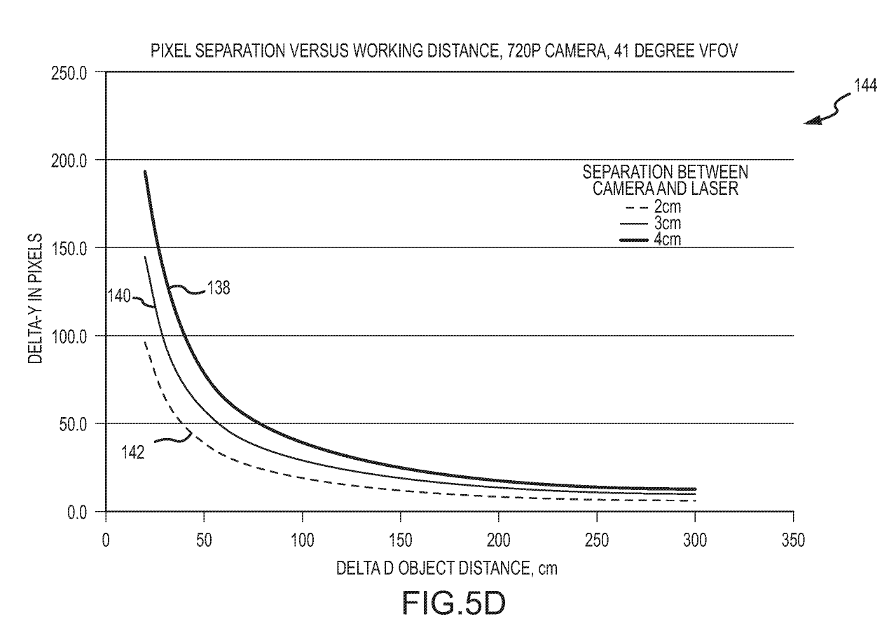

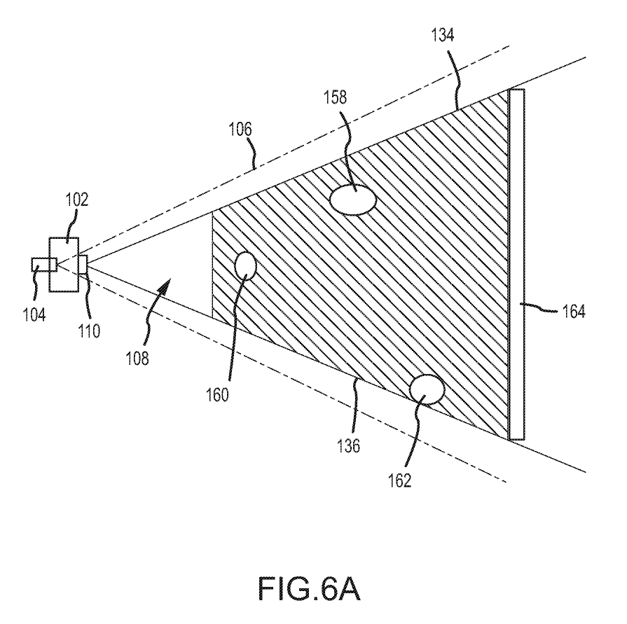

The laser source 104 may be positioned adjacent the image capturing device 102. In some examples, the laser source 104 may be positioned near the sides, top, or bottom of the image capturing device 102. It should be noted that the laser source 102 may be positioned at substantially any location, as long as the beam 106 is configured to at least partially intersect with the FOV 108 of the image capturing device 102. A separation distance between the laser source 104 and the image capturing device 102 may affect a depth analysis for objects as well as affects a sensitivity of the system 100. This is discussed in more detail below with respect to FIGS. 5A-5D.

In some embodiments, the image capturing device 102 and the laser source 104 may be separated from one another by a distance of approximately 2 to 4 centimeters. In these embodiments, the distance of an object with respect to image capturing device 102 may be more accurately determined, as depth of the object may be calculated based on an image of the beam 106. Additionally, the closer the laser source 104 is located to the image capturing device 102, any potential blind spot may be reduced. For example, if the laser source 104 is positioned far away from the image capturing device 102, an object located close to the image capturing device 102 may not intersect the beam 106. It should be noted that other distances and positions between the laser source 104 and the image capturing device 102 are envisioned and may be varied depending on the application and/or device implementing the system 100.

The beam 106 may be projected onto an object within the FOV 108 of the lens 110. As the beam 106 is projected onto a particular object, the resulting image of the beam 106 may be captured by the image capturing device 102. The location of the beam 106 within the FOV 108 may then be analyzed to determine the object's distance or depth from the image capturing device 102. For example, the system 100 may be able to determine a depth of an object on which the beam 106 is projected by correlating a pixel height of the reflected beam 106 with a distance to the object.

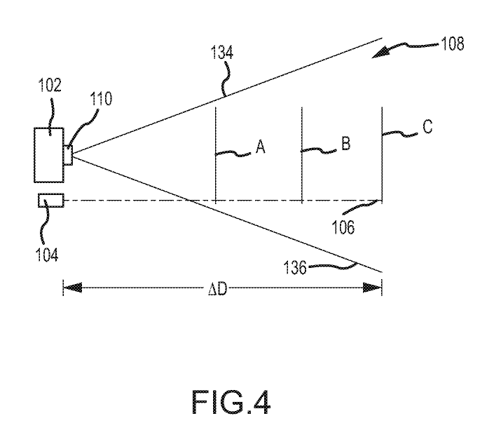

FIG. 4 is a side elevation view of a diagram of the system 100, with the beam 106 projecting onto a first object A, a second object B, and a third object C within the FOV 108 of the image capturing device 102. The first object A is closer to the laser source 104 and image capturing device 102 than the second object B, and the second object B may be closer than the third object C. The distance of each object A, B, C from the image capturing device 102 may be generally stated as delta D.

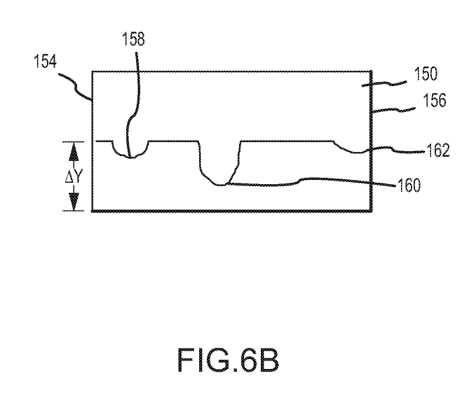

FIGS. 5A, 5B, and 5C illustrate exemplary images illustrating a bottom point of the projected beam 106 with respect to an object that may be captured by the image capturing device 102 or otherwise determined by the sensor 114. FIG. 6B illustrates an image of the entire beam 106 as reflected from an object, and not just a single point.

To produce the images as shown in FIGS. 5A-5C, the sensor 114 and/or the lens 110 may include an optical filter, multiple images may be taken, or the image may otherwise be processed in order to isolate the image of beam 106. This may be done in order to decrease the complexity of calculations and processing for analyzing the image to determine a depth of each object. By isolating an image of the beam 106, the beam 106 can be analyzed without including viewing any objects that are present within the FOV 108.

FIG. 5A is an image of a point of the beam 106 reflected from the first object A, FIG. 5B is an image of the beam 106 reflected from the second object B, and FIG. 5C is an image of the beam 106 reflected from the third object C. The bottom edge 126 of the image 130 may be correlated to a bottom edge 136 of the FOV 108 as shown in FIG. 4. Similarly, a top edge 124 of the image 130 may be correlated to a top edge 134 of the FOV 108 in FIG. 4, and a center line 128 of the image 130 may correlate to a middle or center of the FOV 108 in FIG. 4. It should be noted that in other examples and system configurations the edges of the image 130 may correspond to other portions of the FOV 108.

Generally, delta Y is the distance between the centerline of the FOV (and the image) and the bottom of the image. The actual height or delta Y number of a point displayed on the image 130 (as measured from a centerline of the FOV 108) correlates to the distance D that the object is from the image capturing device 102. Referring now to FIG. 5A, as the first object A is rather close in FIG. 4 to the laser source 104, the point of the beam 106 reflection off of object A is substantially adjacent the bottom edge 126 of the image 130 and may have a larger delta Y.

Similarly, referring to FIG. 5C, the third object C is positioned farthest away from the image capturing device 102 the point of the beam 106 reflection for the third object C has a delta Y or height on the image 130 that may be close to the center line 128 of the image 130. Finally, referring to FIG. 5B, the image 130 illustrating the point of the beam 106 reflection off of the second object B may display the second object B reflection as having a delta Y between the first object A and the third object C.

Referring to FIGS. 5A-5C, the distance an object is from the image capturing device 102 is related to the height that the reflection of the beam 106 corresponding to the object may be displayed in the image 130 of the beam 106. In some instances, the depth sensitivity of the system 100 may decrease the farther away an object is from the image capturing device 102. However, for objects that are close to the image capturing device 102, the sensitivity may substantially increase. In some embodiments, an increased sensitivity closer to the image capturing device 102 may be preferred over a sensitivity for distances farther away from the image capturing device 102. For example, in some implementations, the system 100 may capture finger movements, small objects, or other objects/movements that may be close to the image capturing device 102.

FIG. 5D is a graph illustrating an exemplary relationship between a sensitivity of the system 100 in determining an object's depth and the distance between the image capturing device 102 and the laser source 104. The graph 144 includes data for an image capturing device 102 that is a 720 progressive scan camera including a 41 degree vertical field of view.

The graph 144 may include a horizontal axis including varying distances (delta D) between the image capturing device 102 and an object. The vertical axis may include a height of the image (delta Y) as determined by the number of pixels. In other words, the height may be determined by the number of pixels between the reflected laser beam 106 image and the center of the FOV 108. The delta D distance on the graph ranges from 0 centimeters to 350 centimeters and the delta Y ranges from 0 pixels to 250 pixels. It should be noted, that in other embodiments, the curves 138, 140, 142 and the horizontal and vertical axes may be varied and FIG. 5D is only a single example.

With continued reference to FIG. 5D, three separate relationships are graphed, a first curve 138 represents a sensitivity relationship for a separation distance between the image capturing device 102 and the laser source 104 of approximately 4 centimeters. A second curve 140 represents the relationship for a separation distance of approximately 3 centimeters. A third curve 142 represents the relationship for a separation distance of approximately 2 centimeters.

Each curve 138, 140, 142 may have an increased delta Y height or pixel number difference for depth distances or delta D distances between 0 to 100 centimeters. This is because, as described briefly above, the sensitivity of the system 100 may decrease for objects that are farther way. It should be noted that the system 100 is able to estimate an object's depth from the image capturing device 102 at farther distances than 100 centimeters, but the sensitivity may be decreased. The increased difference in pixels for the delta Y heights for smaller distances allows for the system 100 to more accurately determine depth for closer objects.

In other examples, the laser source 104 may be positioned so that there may be large angle between a center of the FOV 108 and the beam 106. In these examples, the sensitivity of the system 100 may be increased for objects that are farther away from the image capturing device 102. This is because the distance between the center of the FOV 108 and the beam 106 reflection may change as the angle of the laser source 104 is altered. Due to the increased angle between the beam 106 and the image capturing device 102, the system 100 may have a blind spot for objects that are very close to the image capturing device 102. However, depending on the desired application or use for the system 100, the increased distance sensitivity may be preferred regardless of a blind spot.

FIG. 6A is a top plan view of the system 100 with the beam 106 being projected onto three objects 158, 160, 162 and against a planar surface 164. The first object 160 is positioned closest to the image capturing device 102 and substantially directly aligned with the lens 110, the second object 158 is positioned farther away from the image capturing device 102 than the first object 160 and is closer towards a left edge 134 of the FOV 108. The third object 162 is positioned farthest away from the image capturing device 102 and partially intersects with the right edge 136 of the FOV 108. The planar surface 164 may be a wall or other substantially flat surface on which the beam 106 may eventually reach when being projected from the laser source 104.

FIG. 6B is an exemplary image that may be captured by the image capturing device 102 correlating to the reflection of the beam 106 on the first object 160, the second object 158, the third object 162, and the planar surface 164. The delta Y as shown in FIG. 6B indicates the axis from which the beam 106 reflection is measured from the centerline of the FOV 108 to determine a particular object's depth. The image 150 may include a left edge correlating to a left edge 134 of the FOV 108 (as viewed in the top view of FIG. 6A) and a right edge of the image correlating to a right edge 136 of the FOV 108 (as viewed in FIG. 6A). In other configurations, the bottom edge 156 and the top edge 154 of the image 150 may correlate to other portions of the FOV 108.

As the beam 106 encounters each object 158 160, 162, the beam 106 may curve or be reflected around the surface. In other words, the beam, 106 may at least partially trace the a portion of the surface of each object 158, 160, 162. In some examples the beam 106 may trace only the portion of the object 158, 160, 162 that may be facing the laser source 104. Similarly, the beam 106 may trace along the surface of the planar surface 162, which, as shown in FIG. 6B is a substantially flat outline. As shown in FIG. 6A, the three objects 158, 160, 162 may have a generally oval shaped body facing towards the image capturing device 102. Therefore, as shown in FIG. 6B, the beam 106 reflection for each object 158, 160, 162 may be substantially similar to the front surface of the objects 158, 160, 162, that is curved.

A bottom point of the curvature on the image 150 may correlate to a front surface of the respective object with respect to the image capturing device 102. In other words, the delta Y height of a bottom of beam 106 as altered by each object correlates to the closest depth or distance that the object is from the imaging capturing device 102.

With continued reference to FIG. 6B, the third object 162 beam 106 manipulation may intersect with a border of the image 150. This is because the third object 162 is positioned against the FOV 108 of the image capturing device 102, and therefore the total shape of the beam 106 may not be captured.

The system 100 may capture the image 150 of the beam 106 projected onto various objects within the FOV 108 of the image capturing device 102 in a number of different manners. In one example, the image capturing device 102 may take a first image with the laser source 104 turned off so that the beam 106 is not present and then may take a second image with the laser source 104 turned on and with the beam 106 projected. The processor 118 may then analyze the two images to extract an image of the beam 106 alone. In another example, the image capturing device 102 may include a filter such as a wavelength or optical filter and may filter out wavelengths different from the beam 106 wavelength. In this example, the beam 106 may be isolated or removed from other aspects of the image 150. The isolation of the beam 106 may assist in evaluating the resulting shape or deformed shape of the beam 106 to determine object depth.

Once the image 150 of the beam 106 reflection is captured, a second image may be captured of the scene. The image 150 of the beam 106 and an image of the scene may be compared so that the depth of each object illustrated in the image of the scene may be determined. Additionally, as the beam 106 may project around a portion of the surface area of an object, a rough surface map of that portion of the object may be determined.

It should be noted that the image 150 of the beam 106 may be used on its own (that is, not compared to a scene image) or may be used in combination with other data and scene information. This may allow the image 150 to provide only depth determination for objects near the image capturing device 102 or may be used to provide additional data for objects photographically captured, sensed, or the like.

### Additional Embodiments

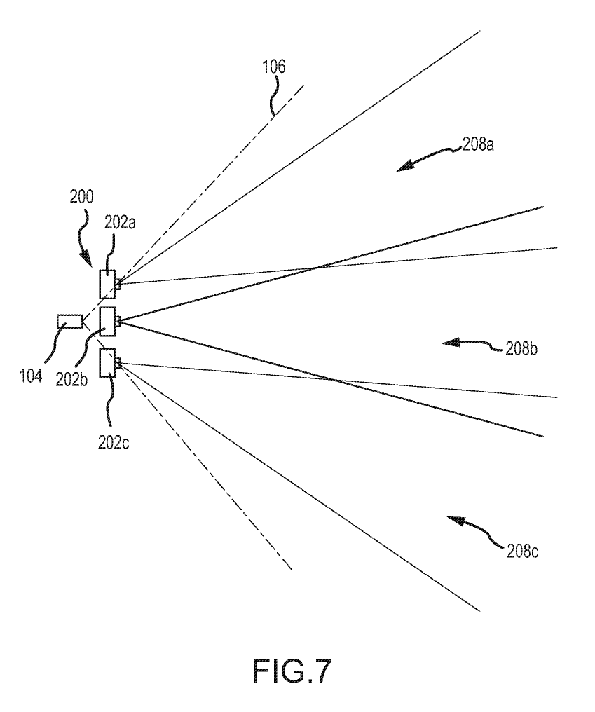

FIG. 7 is a top view of a second embodiment of the system for determining depth. In this embodiment, the system 200 may include an array of image capturing devices 202a, 202b, 202c. The laser source 104 may project the beam 106 so as to at least partially intersect a portion of a FOV 208a, 208b, 208c of each image capturing device 202a, 202b, 202c. In this embodiment, the total FOV for the system 200 may be increased. In one example, the total FOV for the system 200 may be approximately 180°.

Each image capturing device 202a, 202b, 202c may capture a portion of an image of the total FOV onto a single sensor 114. In this manner, the sensor 114 may have an image formed for each FOV 208a, 208b, 208c on different regions of the sensor 114. In another example, each image capturing device 202a, 202b, 202c may capture an image onto its own particular sensor. The resulting images of the scene may be combined or “stitched” together to form a single image for the total FOV. In the embodiment of FIG. 7, the system 200 may be calibrated in order to adjust a “hand-off” or seam of a particular image for a certain area of the total FOV. In this manner, the image capturing device 202a, 202b, 202c that may be best suited or otherwise positioned to capture the particular portion of the FOV may be used to create the portion of the image of that FOV.

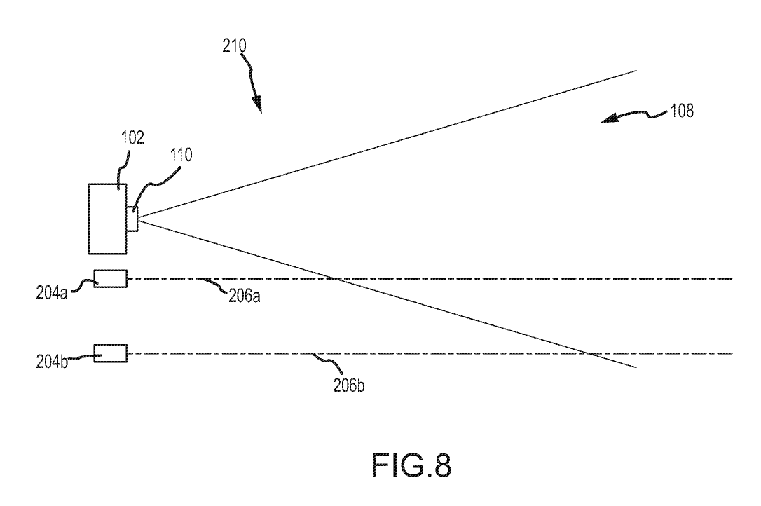

FIG. 8 is a side view of a third embodiment of the system for determining depth. In this embodiment, the system 210 may include the image capturing device 104 having the FOV 108, but may include two laser sources 204a, 204b each projecting a beam 206a, 206b. Each beam 206a, 206b may provide additional depth or distance information for objects positioned in front of the image capture device 102. This is possible because the two beams 206a, 206b will provide additional data that can refine and increase the sensitivity of the depth determination.

In one example, the two beams 206a, 206b may be positioned to project on different areas of the FOV 108. This may be helpful because in some instances the FOV 108 of the image capturing device 102 may include a volume of space, but each beam 206a, 206b may only be two-dimensional and thus the additional of another beam provides additional information. This may further allow the distance of various objects within the FOV 108 but not in a plane of a single beam be determined, e.g., if an object is positioned above or below a height of the a beam. This is possible because by adding two beams, the chance that at least one of the beams will encounter an object increases. Additionally, this example may be helpful to better determine an overall depth of an object, as some objects may have curved surfaces or multiple widths, and may have a first distance to the image capturing device 102 at a first portion of the object and a second distance to the image capturing device 102 at a second portion.

FIG. 9 is a side view of a fourth embodiment of a system for determining depth. In this embodiment, the system 260 may include two separate image capturing devices 202a, 202b each including its own laser source 204a, 204b and beam 206a, 206b. Each capturing device 202a, 202b (as well as their associated beams 206a, 206b) are angled in different directions from each other. In this manner a first capturing device 202a and a first beam 206a may be able to determine a distance of objects within a first FOV 208a. The second capturing device 202b and the second beam 206b may determine the distance of objects within a second FOV 208b.

The two FOVs 208a, 208b may be directed so as to not overlap or to partially overlap. In this manner, the system 260 may capture depth information for a larger area. Essentially, the system 260 may provide additional information regarding the distance to various objects within a full spatial region. Furthermore, in this embodiment, the system 260 may be able to track objects on different sides or angles with respect to a single image capturing device.

In one example, the two separate image capturing devices 202a, 202b may be integrated into a single device and therefore the two separate FOVs 208a, 208b may be essentially combined to increase the spatial region for detecting depth of an object.

FIG. 10 illustrates a fifth embodiment of a system for determining depth of an object. In this system 300, a single image capturing device 302 may include multiple lenses 310. For example, the image capturing device 302 may include a three by three lens array. In this example, the lenses 310 may functionally create nine separate image capturing devices 302, in that each lens 310 may include a separate FOV 308 and capture a separate image. In other examples, other lens arrays are possible, such as but not limited to, a two by two or a four by four lens array.

The system 300 may include three laser sources 304a, 304b, 204c each projecting a different beam 306a, 306b, 306c. In one example, each beam 306a, 306b, 306c may be emitted at a different angle from the others, e.g., a first beam 306a may be steeply angled upward with respect to a horizontal plane, a second beam 306b may be moderately angled upward from a horizontal plane, and a third beam 306c may be substantially horizontal. In this example, each beam 306a, 306b, 306c may project onto objects that may be positioned in the FOV 308 of one of the lenses 310. Additionally, the beams 306a, 306b, 306c may be able to project onto objects that may be positioned at a variety of angles with respect to the image capturing device 302.

### Applications for the Depth Sensing System

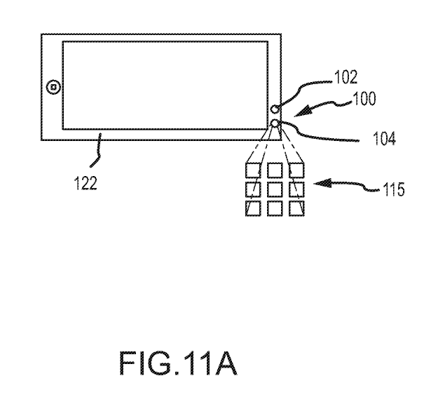

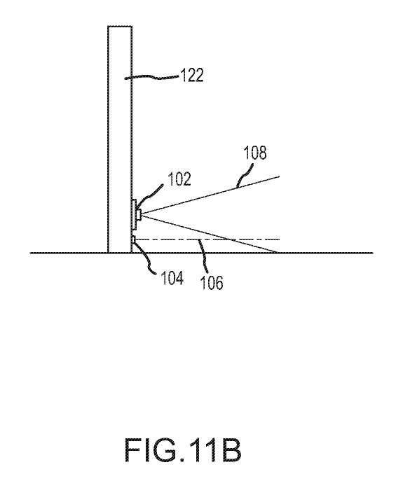

As described above with respect to FIGS. 3A-3C, the depth sensing system 100 may be incorporated into a number of different devices, such as a computer 120 or mobile electronic device 122. FIG. 11A illustrates the system 100 incorporated into a mobile electronic device 122. In this example, the system 100 may be used in combination with a projected control panel 115 (such as a keyboard, audio/video controls, and so on). The control panel 115 may be a light pattern projected from a light source onto a surface (e.g., table or desk), the control panel 115 may include different light shapes, colors, or the like for representing different inputs.

The system 100 may determine the selection of a particular button or input of the control panel 115 by determining the depth of a user's finger, a stylus, or other input mechanism. The depth of the object may then be compared to a distance of each key or button of the control panel 115. Additionally, as the beam 106 of the laser source 104 may be emitted in a non-visible wavelength and therefore may not interfere with the control panel 115 appearance. In this embodiment, the system 100 may provide for an enhanced projected control panel 115, which may allow for mobile electronic devices to decrease in size as a keyboard, or other input mechanism may be able to be projected larger than the mobile electronic device 122.

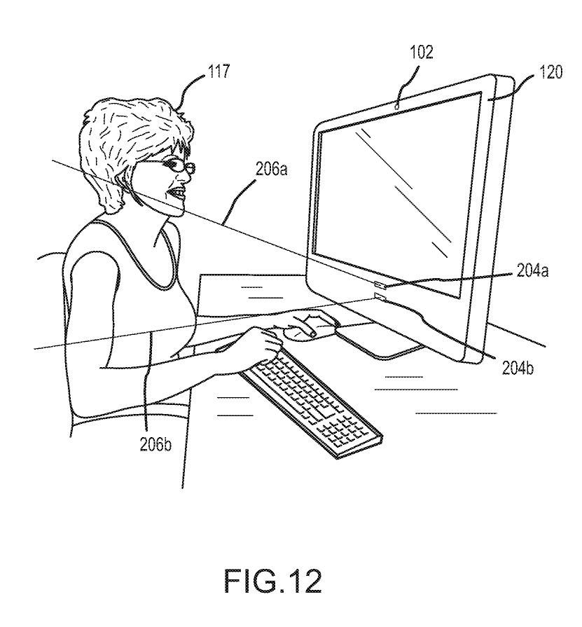

FIG. 12 is a example of the computer 120 incorporating the system 210. In this example, the computer 120 is able to detect a user approaching the computer 120, which may allow the computer 120 to activate a particular program, application, awake from sleep or power save mode, and the like. In this example, the computer 120 is incorporated with the system 210 illustrated in FIG. 8. In this manner, the computer 120 may include the capturing device 202 on a top portion of the display screen and the first laser source 204a and the second laser source 204b positioned underneath the display screen. In this manner, the beams 206a, 206b may include different angles, so as to be able to project onto an object or user positioned at a various heights and/or angles.

Referring to FIG. 12, a user 117 may be positioned in front of the computer 120 such that the first and second beams 206a, 206b may at least partially intersect the user. The image capturing device 202 and/or the computer 120 may then be able to determine the distance that the user 117 is from the computer 120. The system 210 increases the sensitivity of user detection for the computer 120, which may help the computer 120 to be able to make a distinction between the user 117 and another object, such as a chair, which may be positioned in front of the computer 120 as well. This is because, the user 117 may not be determined to be in front of the computer 120 unless both beams 206a, 206b intersect or project onto an object. As one beam 206a is angled upwards it may be positioned to be higher than a chair. In this manner the system 210 may be able to detect when a user approaches, as both beams 206a, 206b will be projected off an object.

In still other examples, the depth sensing system may be used to auto focus a camera, as the system may determine the depth of an object and the lens may then be automatically adjusted to focus on that depth.

### CONCLUSION

The foregoing description has broad application. For example, while examples disclosed herein may focus on depth sensing, it should be appreciated that the concepts disclosed herein may equally apply presence and movement sensing. Similarly, although depth sensing system may be discussed with respect to computers, the devices and techniques disclosed herein are equally applicable to other devices, such as automobiles (e.g., virtual locks, stereo controls, etc.), digital video recorders, telephones, security systems, and so on. Accordingly, the discussion of any embodiment is meant only to be exemplary and is not intended to suggest that the scope of the disclosure, including the claims, is limited to these examples.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

What is claimed is:

1. A system for determining a distance to a object comprising:
a first image capturing device; and
a first laser source configured to emit a first fan shaped laser beam to intersect at least a portion of a field of view of the image capturing device.

2. The system of claim 1, wherein the image capturing device further comprises:
a sensor configured to capture an optical image; and
a lens in optical communication with the sensor.

3. The system of claim 1, further comprising an electronic device in communication with the first image capturing device.

4. The system of claim 1, further comprising a second laser source configured to emit a second fan shaped beam to intersect at least another portion of the field of view of the first image capturing device.

5. The system of claim 4, further comprising a second image capturing device, wherein the second laser source is configured to emit the second fan shaped laser beam to intersect at least a portion of a field of view of the second image capturing device.

6. The system of claim 4, wherein the first image capturing device further comprises a first lens and a second lens.

7. The system of claim 6, wherein the first image capturing device further comprises a lens array.

8. An electronic device comprising:
a processor;
a camera in communication with the processor; and
a first laser source configured to emit a first fan shaped laser beam to intersect at least a potion of a field of view of the camera.

9. The electronic device of claim 8, wherein the camera is configured to take a first image prior to the first fan shaped laser beam being emitted and to take a second image while the first fan shaped laser beam is being emitted.

10. The electronic device of claim 8, wherein the electronic device is a smart phone.

11. The electronic device of claim 8, wherein the electronic device is a computer.

12. The electronic device of claim 8, further comprising a second laser source configured to emit a second fan shaped laser beam to intersect at least a portion of the field of view of the camera.

13. The electronic device of claim 12, wherein the first fan shaped laser beam and the second fan shaped laser beam are configured to be emitted at a different angle from each other.

14. The electronic device of claim 12, wherein the camera further comprises a lens array including at least a first lens and a second lens.

15. A method for determining a distance to an object, comprising:
emitting from a light source a directional fan-shaped beam of light to encounter the object;
capturing by an image capturing device a beam image of a reflection of the directional fan-shaped beam; and
analyzing by a processor the reflection of the directional fan-shaped beam to determine the distance to the object.

16. The method of claim 15, further comprising:
prior to emitting the directional fan-shaped beam, capturing by the image capturing device a scene image; and
comparing by the processor the scene image to the beam image to isolate the reflection of the directional fan-shaped beam.

17. The method of claim 15, wherein the directional fan-shaped beam is a laser.

18. The method of claim 15, wherein the directional fan-shaped beam is an incoherent beam.

19. The method of claim 15, wherein the directional fan-shaped beam has a non-visible light wavelength.

20. The method of claim 15, wherein the directional fan-shaped beam has a visible light wavelength.
